(19) United States
(12) Patent Application Publication
(10) Pub. No.: US 2017/0239022 A1
(43) Pub. Date: Aug. 24, 2017

(54) DRILL HEAD STRUCTURE FOR DENTAL HANDPIECE

(71) Applicant: SHIH-CHIEH SU, Taipei City (TW)

(72) Inventor: SHIH-CHIEH SU, Taipei City (TW)

(21) Appl. No.: 15/046,463

(22) Filed: Feb. 18, 2016

(51) Int. Cl. A61C 8/00; A61C 3/02

(52) U.S. Cl. CPC A61C 8/0089; A61C 3/02

(57) ABSTRACT

The present invention discloses a drill head structure for dental handpiece comprising a drill head main body, a screw nut and an adjusting ring. The drill head main body may be attached to a driving end of a dental handpiece so that the drill head main body may be driven by the dental handpiece to rotate at high speed. On the drill head main body is disposed a thread section. The screw nut is a hexagonal nut to be screwed to the thread section of the drill head main body. The adjustment ring has predetermined ring widths, and at a center thereof is disposed a hexagonal screw nut indent for the screw nut to be fitted into it. At a center of the adjustment ring is also disposed a threaded hole to be screwed to the foregoing thread section. The dental bone drill structure provided according to the present invention may achieve the purpose of controlling the drilling depth to which the drill head goes in and determine the drilling position.

### BACKGROUND OF THE INVENTION

1. Field of the Invention

The present invention relates to a drill head structure, particularly a drill head structure for dental handpiece which is used in dental implant surgery for drilling a hole in an alveolar bone in an affected area in the mouth.

2. Description of Related Art

An artificial dental implant technology has been applied in oral cavity treatment for years. Development in dental implant materials and improvement in dental implant technology have contributed to a greatly increased success rate of dental implant surgery and have effectively solved problems with conventional dental prostheses for patients with missing teeth. The foregoing artificial dental implant surgery primarily involves placing an implant body in an alveolar bone in an affected area in the mouth to replace an extracted tooth root, attaching and securing the implant body to an abutment, and fixing a crown to the abutment. An artificial replacement is thus formed to replace a lost tooth.

In a conventional dental implant procedure, a drill head is attached to a dental handpiece for drilling a hole in an alveolar bone in an affected area in the mouth of the patient so that the implant body may be placed and screwed into the alveolar bone. Before the dentist starts drilling a hole, a position in the affected area has to be planned for the hole. An optimal position for the hole is usually a center between two teeth in the affected area. For the time being, the position of the hole may only be determined after inspection with the naked eye by an experienced professional dentist. Further, the depth of the hole is determined after evaluating factors such as the condition of the patient's alveolar bone and the size of the implant body. An overdeep or shallow hole will affect whether the implant body is successfully and stably placed or not. Therefore, the dentist has to carefully monitor drilling depth to facilitate placement of the implant body.

With regard to the foregoing problems, drill heads which are currently used in drilling holes in alveolar bones are of little substantial help. They depend solely on the operation and control of the dentists, and hence flaws may be caused by human errors and remissness. Therefore, there is need for a novel and improved drill head to solve the foregoing problems.

### SUMMARY OF THE INVENTION

It is a primary purpose of the present invention to address problems with dental bone drilling caused by design defects of drill head structures. A drill head structure is provided in the present invention which may be used for drilling a hole in an alveolar bone, control the depth to which the drill head end goes in, and assist in determining a precise position for drilling to facilitate the placement of the implant body and improve its steadiness.

A dental bone drill structure provided according to the present invention comprises a drill head main body, a screw nut and an adjusting ring. The drill head main body is a thin rod body with an upper end that forms an attachment portion to be attached to a driving end of a dental handpiece so that the drill head main body may be driven by the dental handpiece to rotate at high speed. A bottom end of the drill head main body forms a drilling portion for drilling by cutting. In particular, above the drilling portion is disposed a thread section. The screw nut is a hexagonal nut to be screwed to the thread section of the drill head main body. The adjustment ring has predetermined ring widths, and at a center thereof is disposed a hexagonal screw nut indent for the screw nut to be fitted into it. At a center of the adjustment ring is also disposed a threaded hole to be screwed to the foregoing thread section. The dental bone drill structure provided according to the present invention may achieve the purpose of controlling the drilling depth to which the drill head goes in and determine the drilling position.

### BRIEF DESCRIPTION OF THE DRAWINGS

FIG. 1 is a three-dimensional exploded structural drawing of a preferred embodiment according to the present invention;

FIG. 2 is a three-dimensional assembly structural drawing of a preferred embodiment according to the present invention;

FIG. 3 is a planar assembly structural drawing of a preferred embodiment according to the present invention;

FIG. 4 is a three-dimensional installation schematic view of an adjusting ring according to the present invention (1);

FIG. 5 is a three-dimensional installation schematic view of an adjusting ring according to the present invention (2);

FIG. 6 is a planar installation schematic view of an adjusting ring according to the present invention.

### DETAILED DESCRIPTION OF THE PREFERRED EMBODIMENTS

The technical content, features and effects of the present invention will be fully demonstrated in the detailed description of its preferred embodiment given herein below and the accompanying drawings. It should be noted that the accompanying drawings are illustrative and exemplary only and intended for the explanation of a basic structure of the present invention. Therefore, it will be appreciated that in the accompanying drawings only structures or components that are relevant to the present invention are shown, and the illustrated forms of structure, size, proportion, or number of components are only one selective design.

The structure of the present invention and the effects it may achieve are demonstrated below in conjunction with the accompanying figures:

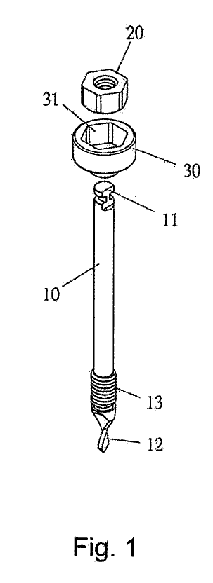

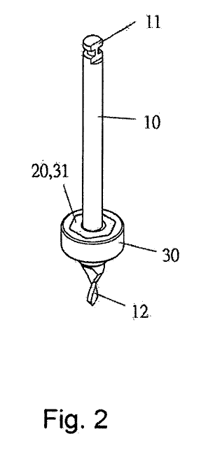

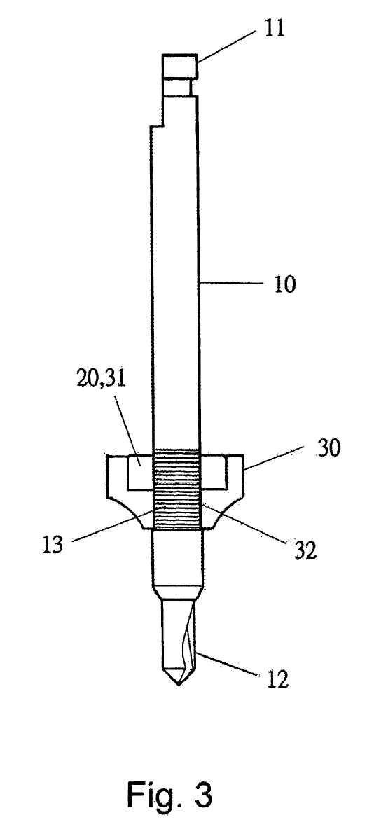

Please first refer to the three-dimensional exploded structural drawing of a preferred embodiment according to the present invention shown in FIG. 1, the three-dimensional assembly structural drawing of a preferred embodiment according to the present invention shown in FIG. 2, and the planar assembly structural drawing of a preferred embodiment according to the present invention shown in FIG. 3. As the figures show, the present invention comprises a drill head main body 10, a screw nut 20 and an adjusting ring 30, wherein:

The drill head main body 10 is a thin rod body with an upper end that forms an attachment portion 11 and a bottom end that forms a drilling portion 12, and above the drilling portion 12 is disposed a thread section 13. The attachment portion 11 is to be attached to a driving end of a dental handpiece so that the drill head main body 10 may be driven by the dental handpiece to rotate at high speed. The drilling portion 12 may drill by cutting.

The screw nut 20 is a hexagonal nut to be screwed to the thread section 13 of the drill head main body 10.

The adjustment ring 30 has predetermined ring widths, and at a center thereof is disposed a hexagonal screw nut indent 31 for the screw nut 20 to be fitted into it. At a center of the adjustment ring 30 is also disposed a threaded hole 32 to be screwed to the thread section 13 of the drill head main body 10.

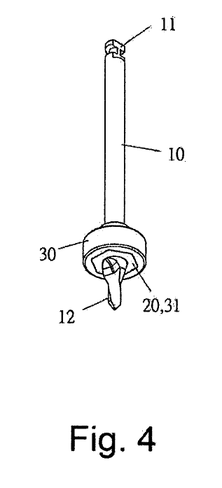

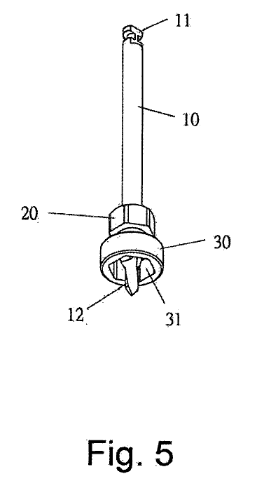

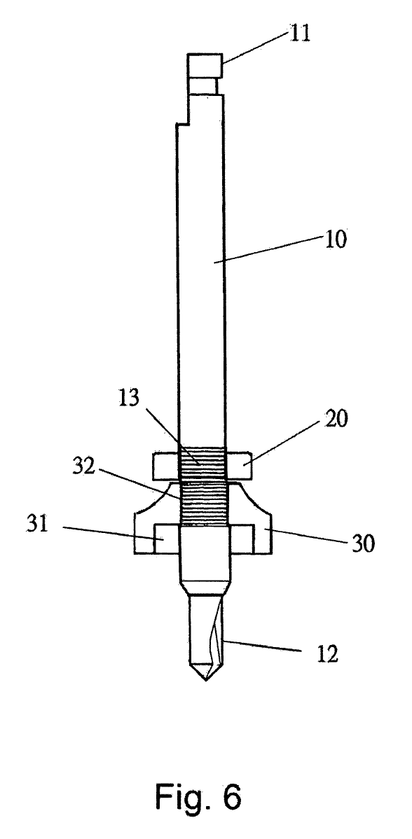

According to the component structure design of the foregoing present invention, the attachment portion 11 is to be attached to a driving end of a dental handpiece so that the drill head main body 10 may be driven by the dental handpiece to rotate at high speed and the drilling portion 12 may drill a hole in an alveolar bone. In particular, the screw nut 20 may be individually screwed to the thread section 13 of the drill head main body 10, or the adjustment ring 30 may be individually screwed to the thread section 13 of the drill head main body 10, or the screw nut 20 may be placed in the screw nut indent 31 of the adjustment ring 30 before being screwed to the thread section 13 of the drill head main body 10. Please also refer to the three-dimensional installation schematic view of an adjusting ring according to the present invention illustrated in FIGS. 4, 5 and 6. By screwing the screw nut 20 and the adjustment ring 30 to the thread section 13 of the drill head main body 10 in different manners, the drilling portion 12 may go into different drilling depths. Further, the adjustment ring has predetermined ring widths which correspond to the spacing between two teeth in the affected area. There are various ring widths for the dentist to choose from. Because the ring widths of the adjustment ring 30 correspond to the spacing between two teeth in the affected area, during the drilling process the drill head main body 10 may be limited by the spacing between two teeth in the affected area and the drilling position may be as planned.

The structure design of the present invention achieves the following advantages:
1. The adjustment ring 30 may be screwed clockwise or counterclockwise so that its position on the thread section 13 of the drill head main body 10 may be adjusted and the drilling portion 12 exposed. This makes it easy for the dentist to steadily control the drilling depth and prevent problems of over or inadequate drilling.
2. The adjustment ring 30 has predetermined ring widths for the dentist to choose from, and the ring widths of the adjustment ring 30 correspond to the spacing between two teeth in the affected area. Therefore, during the drilling process of the drill head main body 10, the adjustment ring 30 may provide a guiding function for a drilling position so that the drilling position may be as planned.

As the foregoing, the prevent invention primarily comprises a drill head main body 10, a screw nut 20, and an adjustment ring 30. It may be attached to a dental handpiece for drilling a hole in an alveolar bone, control the depth to which the drill head end goes in the bone, and assist in guiding and determining a precise position for drilling to facilitate the placement of the implant body and improve its steadiness. However, it should be noted that the structural content of the foregoing components is only illustrated of a preferred embodiment of the present invention rather than limiting of the present invention. It is intended to cover various modifications and changes included within the spirit and scope of the appended claims, the scope of which should be accorded the broadest interpretation so as to encompass all such modifications and similar structures.

1. A drill head structure for dental handpiece comprising a drill head main body, a screw nut and an adjusting ring; the drill head main body is a thin rod body with an upper end that forms an attachment portion to be attached to a driving end of a dental handpiece so that the drill head main body may be driven by the dental handpiece to rotate at high speed, and a bottom end of the drill head main body that forms a drilling portion for drilling by cutting; above the drilling portion is disposed a thread section; the screw nut is a hexagonal nut to be screwed to the thread section of the drill head main body; the adjustment ring has predetermined ring widths, and at a center thereof is disposed a hexagonal screw nut indent for the screw nut to be fitted into it; at a center of the adjustment ring is also disposed a threaded hole to be screwed to the thread section of the drill head main body, wherein the predetermined ring widths are correspond to the spacing between two teeth in the affected area.
